(19) United States
(12) Patent Application Publication
(10) Pub. No.: US 2022/0092290 A1
(43) Pub. Date: Mar. 24, 2022

(54) Image Recognition Method And Robot System

(71) Applicant: Seiko Epson Corporation, Tokyo (JP)

(72) Inventor: Takeshi YOSHIDA, Shiojiri (JP)

(21) Appl. No.: 17/481,453

(22) Filed: Sep. 22, 2021

(30) Foreign Application Priority Data
Sep. 23, 2020 (JP) 2020-158303

(51) Int. Cl. G06K 9/00; G06K 9/62; G06T 7/73; B25J 19/04; B25J 13/08

(52) U.S. Cl. CPC G06K 9/00201; G06K 9/6232; B25J 13/08; B25J 19/04; G06T 7/75

(57) ABSTRACT

An image recognition method includes obtaining measurement data of a target object, comparing a 3D model having a plurality of feature points and the measurement data and updating importance degrees of the plurality of feature points based on differences between the 3D model and the measurement data, performing learning using the updated importance degrees, and performing object recognition for the target object based on a result of the learning.

The present application is based on, and claims priority from JP Application Serial Number 2020-158303, filed Sep. 23, 2020, the disclosure of which is hereby incorporated by reference herein in its entirety.

### BACKGROUND

### 1. Technical Field

The present disclosure relates to an image recognition method and a robot system.

### 2. Related Art

JP-A-2010-267232 (Patent Literature 1) describes a position/posture estimation method for estimating a position/posture using 3D model data. In the position/posture estimation method, surface information of the 3D model data is updated based on a photographed image obtained by an imaging device such as a camera.

However, when the 3D model data is updated, it is necessary to perform learning again based on the updated 3D model data. Large labor and time are required to make it possible to resume position/posture estimation for a target object.

### SUMMARY

An image recognition method according to an aspect of the present disclosure includes: obtaining measurement data of a target object; comparing a 3D model having a plurality of feature points and the measurement data and updating importance degrees of the plurality of feature points based on differences between the 3D model and the measurement data; performing learning using the updated importance degrees; and performing object recognition for the target object based on a result of the learning.

A robot system according to an aspect of the present disclosure includes: a gripping section configured to grip a target object; an imaging device configured to image the target object; and an object recognition processing device configured to recognize an object based on an image captured by the imaging device. The object recognition processing device performs image recognition for the target object through a step of obtaining measurement data of the target object, a step of comparing a 3D model having a plurality of feature points and the measurement data and updating importance degrees of the plurality of feature points based on differences between the 3D model and the measurement data, a step of performing learning using the updated importance degrees, and a step of performing object recognition for the target object based on a result of the learning. The gripping section grips the target object based on a result of the object recognition by the object recognition processing device.

### BRIEF DESCRIPTION OF THE DRAWINGS

FIG. 1 is a diagram showing an overall configuration of a robot system in a first embodiment.

FIG. 2 is a block diagram showing the configuration of an object recognition processing device included in the robot system shown in FIG. 1.

FIG. 3 is a flowchart showing the operation of the robot system.

FIG. 4 is a flowchart showing teaching work.

FIG. 5 is a diagram showing a 3D model of an object and the object in a real world.

FIG. 6 is a diagram showing an example of an image displayed on a monitor.

FIG. 7 is a diagram showing an example of an image displayed on the monitor.

FIG. 8 is a diagram showing an example of a position/posture in which a large difference point easily appears in a contour shape.

FIG. 9 is a diagram showing an example of a position/posture in which a large difference point less easily appears in a contour shape.

FIG. 10 is a flowchart showing object recognition work and gripping work.

### DESCRIPTION OF EXEMPLARY EMBODIMENTS

An image recognition method and a robot system according to the present disclosure are explained in detail below based on an embodiment shown in the accompanying drawings.

### First Embodiment

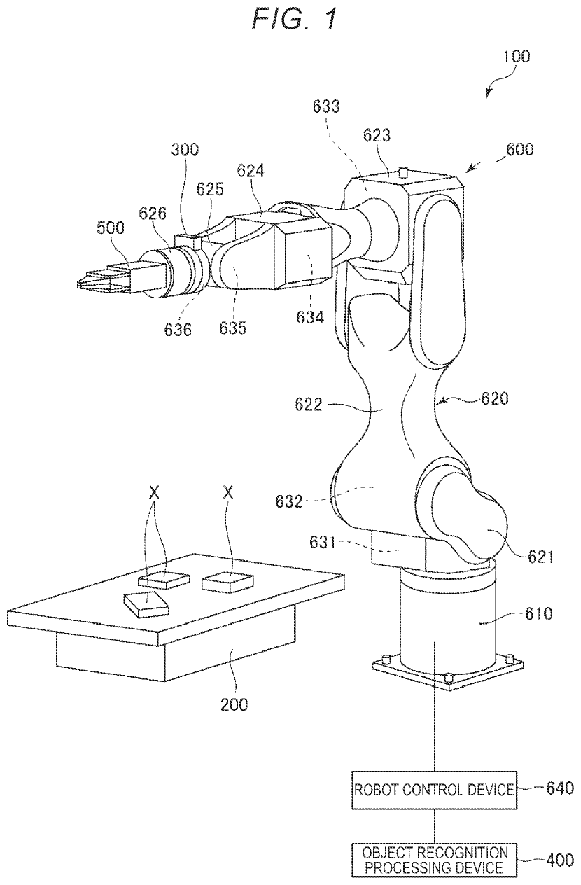

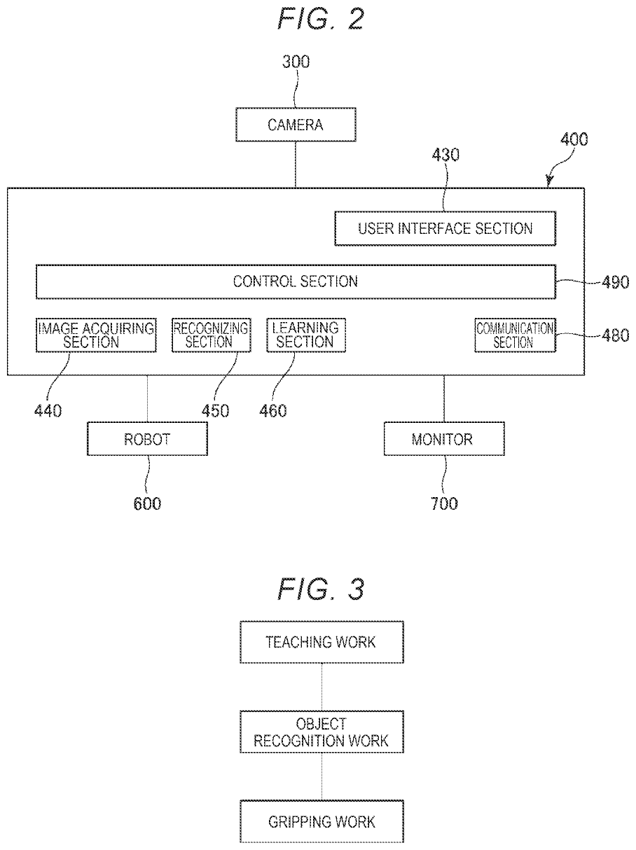

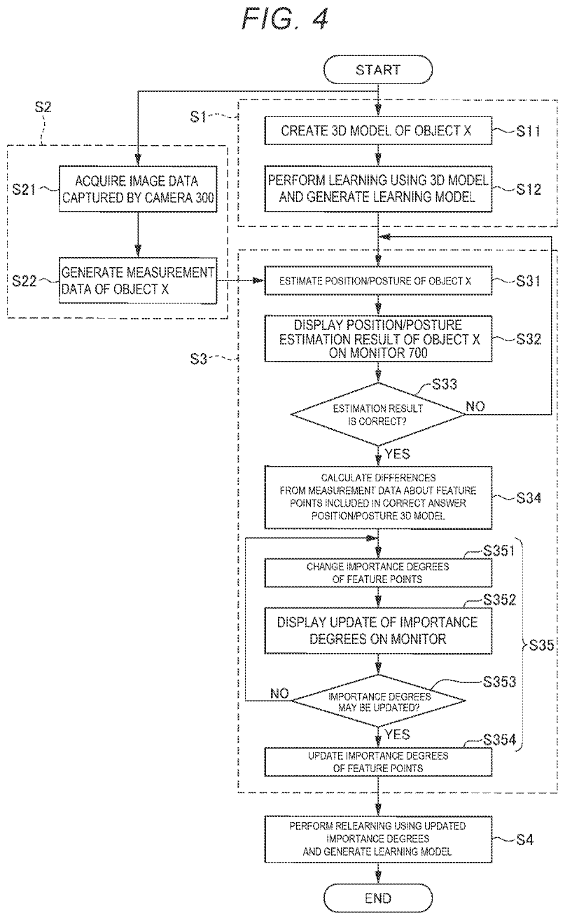

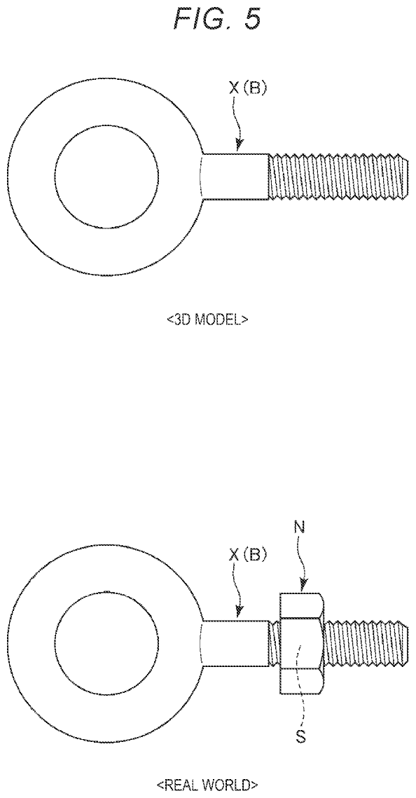

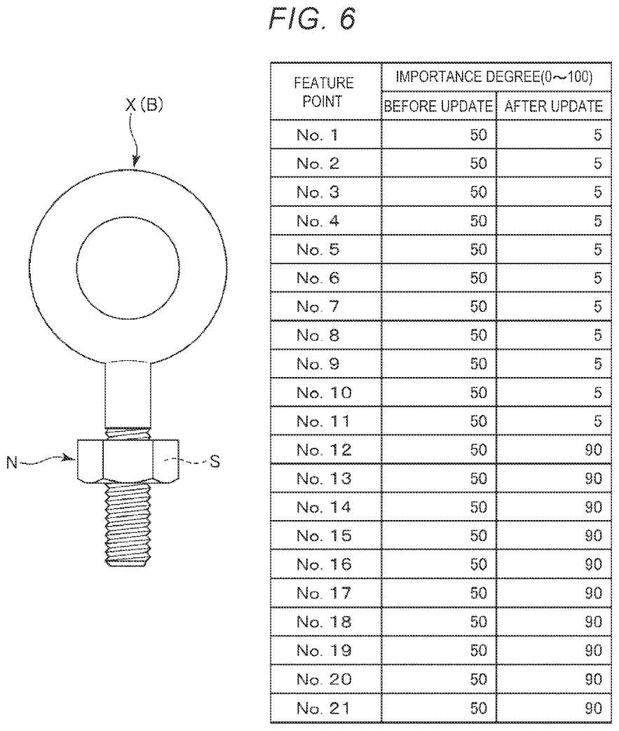

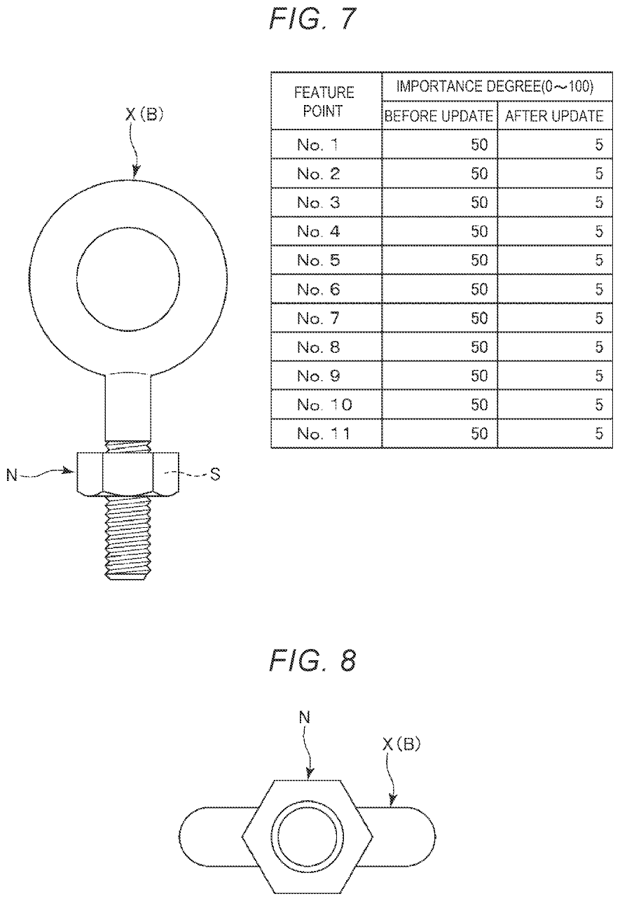

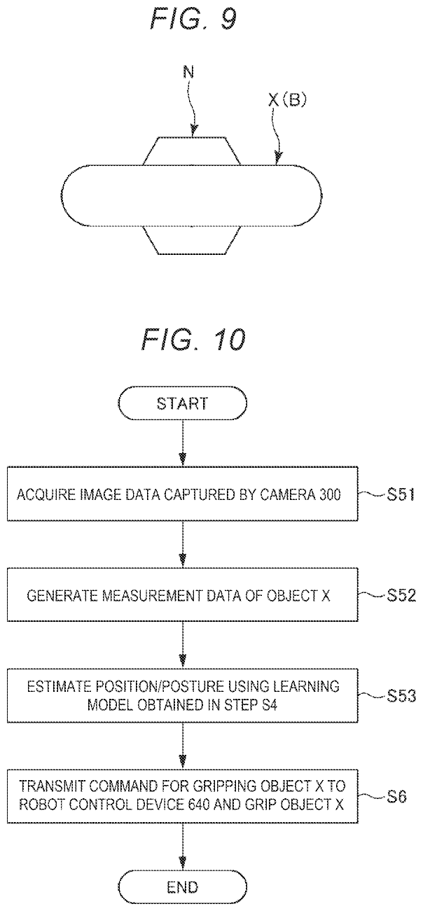

FIG. 1 is a diagram showing an overall configuration of a robot system in a first embodiment. FIG. 2 is a block diagram showing the configuration of an object recognition processing device included in the robot system shown in FIG. 1. FIG. 3 is a flowchart showing the operation of the robot system. FIG. 4 is a flowchart showing teaching work. FIG. 5 is a diagram showing a 3D model of an object and the object in a real world. FIGS. 6 and 7 are respectively diagrams showing examples of images displayed on a monitor. FIG. 8 is a diagram showing an example of a position/posture in which a large difference point easily appears in a contour shape. FIG. 9 is a diagram showing an example of a position/posture in which a large difference point less easily appears in a contour shape. FIG. 10 is a flowchart showing object recognition work and gripping work.

A robot system 100 shown in FIG. 1 includes a camera 300 functioning as an imaging device that images an object X functioning as a target object disposed on a placing table 200, an object recognition processing device 400 that performs object recognition processing based on an imaging result of the camera 300, and a robot 600 including a gripping section 500 that grips the object X from the placing table 200 based on an object recognition processing result of the object recognition processing device 400.

The robot 600 is a six-axis robot including six driving axes and is used in work such as holding, conveyance, assembly, and inspection of a workpiece such as an electronic component. A use of the robot 600 is not particularly limited.

The robot 600 includes a base 610 fixed to a floor and an arm 620 coupled to the base 610. The arm 620 includes a first arm 621 coupled to the base 610 and turnable with respect to the base 610, a second arm 622 coupled to the first arm 621 and turnable with respect to the first arm 621, a third arm 623 coupled to the second arm 622 and turnable with respect to the second arm 622, a fourth arm 624 coupled to the third arm 623 and turnable with respect to the third arm 623, a fifth arm 625 coupled to the fourth arm 624 and turnable with respect to the fourth arm 624, and a sixth arm 626 coupled to the fifth arm 625 and turnable with respect to the fifth arm 625.

The gripping section 500 is coupled to the distal end portion of the sixth arm 626. The camera 300 is disposed in the fifth arm 625.

The gripping section 500 is not particularly limited if the gripping section 500 can pick up the object X placed on the placing table 200. The gripping section 500 can be, for example, a component that holds the object X with a pair of claws or a component that attracts the object X with an air chuck, an electromagnetic chuck, or the like.

The camera 300 is disposed to be capable of imaging the distal end side of the gripping section 500. The camera 300 is not particularly limited. In this embodiment, an RGB camera is used. Besides, as the camera 300, for example, a grayscale camera and an infrared camera can be used. For example, a depth sensor that can acquire point group data of the object X may be used instead of or in addition to the camera 300.

In this embodiment, the camera 300 is disposed in the fifth arm 625 of the robot 600. However, the disposition of the camera 300 is not limited to this. The camera 300 may be disposed in, for example, a portion of the arm 620 other than the fifth arm 625. The camera 300 may be fixed to not the robot 600 but, for example, a ceiling above the placing table 200. That is, a relative positional relation between the camera 300 and the placing table 200 may be fixed or may not be fixed.

The robot 600 includes a driving mechanism 631 that turns the first arm 621 with respect to the base 610, a driving mechanism 632 that turns the second arm 622 with respect to the first arm 621, a driving mechanism 633 that turns the third arm 623 with respect to the second arm 622, a driving mechanism 634 that turns the fourth arm 624 with respect to the third arm 623, a driving mechanism 635 that turns the fifth arm 625 with respect to the fourth arm 624, and a driving mechanism 636 that turns the sixth arm 626 with respect to the fifth arm 625. The driving mechanisms 631 to 636 respectively include motors functioning as driving sources, speed reducers that decelerate rotation of the motors, controllers that control driving of the motors, and encoders that detect rotation amounts of the motors.

The robot 600 includes a robot control device 640 that controls driving of the driving mechanisms 631 to 636 and the gripping section 500 based on a command from the object recognition processing device 400. The robot control device 640 is configured from, for example, a computer and includes a processor (CPU) that processes information, a memory communicably coupled to the processor, and an external interface. Various programs executable by the processor are stored in the memory. The processor can read and execute the various programs and the like stored in the memory.

The robot 600 is briefly explained above. However, the configuration of the robot 600 is not particularly limited. Besides the six-axis robot, the robot 600 may be, for example, a horizontal articulated robot (a SCARA robot) or a double-arm robot including a pair of the arms 620 described above. The robot 600 may not be fixed to the floor and may be fixed to an unmanned carriage such as an AMR (Autonomous Mobile Robot) or an AGV (Automatic Guided Vehicle).

Subsequently, the object recognition processing device 400 is explained. The object recognition processing device 400 is configured from, for example, a computer and includes a processor (CPU) that processes information, a memory communicably coupled to the processor, and an external interface. Various programs executable by the processor are stored in the memory. The processor can read and execute the various programs and the like stored in the memory.

As shown in FIG. 2, the object recognition processing device 400 includes a user interface section 430, an image acquiring section 440, a recognizing section 450, a learning section 460, a communication section 480, and a control section 490 that controls these sections. A monitor 700 functioning as an image display device is coupled to the object recognition processing device 400. As shown in FIG. 3, the robot system 100 is configured to execute teaching work, object recognition work, and gripping work. The teaching work is performed by the image acquiring section 440, the recognizing section 450, and the learning section 460. The object recognition work is performed by the image acquiring section 440 and the recognizing section 450. The gripping work is performed by the communication section 480.

First, the teaching work is explained with reference to the flowchart of FIG. 4. The teaching work includes step S1 for performing learning with a 3D model created using CAD (computer-aided design), step S2 for obtaining measurement data of the object X, step S3 for comparing the 3D model and the measurement data and updating, based on differences between the 3D model and the measurement data, importance degrees of a plurality of feature points of the 3D model, and step S4 for performing relearning using the updated importance degrees.

### Step S1

First, in step S11, the learning section 460 creates a 3D model of the object X using the CAD. Subsequently, in step S12, the learning section 460 performs learning based on the 3D model created in step S11. For example, the learning section 460 sets the 3D model in various positions and postures (hereinafter simply referred to as “positions/postures” as well) at 360°, extracts a plurality of feature points from a contour shape (a surface shape) at that time, estimates positions/postures of the object X in the contour shape, and generates a learning model in which the positions/postures are linked. At this stage, importance degrees of the plurality of feature points included in the 3D model in the positions/postures are set to equal to one another. The importance degree is called sensitivity as well. A feature point having a higher importance degree has larger influence on the estimation of the positions/postures.

### Step S2

First, in step S21, the camera 300 images the object X. The image acquiring section 440 acquires image data obtained by the imaging. Subsequently, in step S22, the image acquiring section 440 extracts the object X from the acquired image data and generates measurement data of the object X.

### Step S3

First, in step S31, the recognizing section 450 estimates, using the learning model generated in step S1, a position/posture of the object X in the measurement data generated in step S2. Subsequently, in step S32, the recognizing section 450 displays an estimation result of the position/posture on the monitor 700 and notifies the estimation result to the user. By displaying the estimation result on the monitor 700, the estimation result can be more surely notified to the user and the user can easily check the estimation result. Subsequently, in step S33, the recognizing section 450 requests the user to determine whether the estimation result is correct. By requesting the user to determine whether the estimation result is correct, it is more likely that abnormal estimation can be stopped. Estimation accuracy of the position/posture is improved. The user determines, using various input devices such as a keyboard and a mouse, whether the estimation result of the recognizing section 450 is correct. However, a notifying method and a determining method are not particularly limited.

When it is determined that the estimation result is incorrect, the recognizing section 450 repeats steps S31 to S33 until it is determined that the estimation result is correct. However, not only this, but, for example, the position/posture estimated by the recognizing section 450 may be set as an initial state. The user may finely adjust the position/posture of the 3D model from the initial state and determine a correct position/posture. The user may adjust the position/posture of the 3D model and determine a correct position/posture from the beginning without causing the recognizing section 450 to estimate the position/posture. That is, the user may cause the recognizing section 450 to repeat the estimation until a correct estimation result is obtained, the user may finely adjust the wrong estimation result, or the user may determine the correct position/posture from the beginning.

Conversely, when it is determined that the estimation result is correct, in step S34, the recognizing section 450 compares 3D model adjusted to the position/posture of the measurement data (hereinafter referred to as “correct answer position/posture 3D model” as well) and the measurement data and calculates differences from the measurement data about feature points included in the correct answer position/posture 3D model. The recognizing section 450 converts the calculated differences into numerical values and generates coincidence degrees, which are indicators indicating the magnitudes of the differences. Deviation of the feature points can be calculated based on, for example, deviation of edges, deviation of curvatures, or the like. As shown in FIG. 5, an example in which the object X is a bolt B is explained. Whereas a nut N is not screwed with the bolt B of the 3D model, the nut N is screwed with the bolt B in a real world. Therefore, when the 3D model and the measurement data are compared, a large difference of a feature point occurs in the portion of the nut N. The portion is calculated as a large difference.

Subsequently, in step S35, the learning section 460 updates, based on the difference calculated in step S34, importance degrees of a plurality of feature points included in the correct answer position/posture 3D model. Specifically, first, in step S351, the learning section 460 changes the importance degrees set in the feature points of the correct answer position/posture 3D model such that the importance degrees are lower in the feature points where differences from the measurement data are larger (coincidence degrees with measurement data are lower). In other words, the learning section 460 changes the importance degrees set in the feature points of the correct answer position/posture 3D model such that the importance degrees are higher in the feature points where differences from the measurement data are smaller (coincidence degrees with measurement data are higher).

A method of changing the importance degrees is not particularly limited. For example, the importance degrees of the feature points may be changed in proportion to the magnitudes of the differences. The differences may be divided into a plurality of regions in advance based on the magnitudes of the differences, importance degrees may be set for each of the regions, and the importance degrees of the feature points may be changed by applying the importance degrees corresponding to the magnitudes of the differences to the set importance degrees.

As explained above, in this embodiment, since the large difference of the feature point occurs in the portion of the nut N, the portion is calculated as the large difference. Accordingly, the learning section 460 sets an importance degree of a feature point located in a region S overlapping the nut N lower than an importance degree of a feature point located outside the region S. Alternatively, the learning section 460 sets the importance degree of the feature point located outside the region S higher than the importance degree of the feature point located in the region S. As a result, the importance degree of the feature point located in the region S decreases relatively to the importance degree of the feature point located outside the region S.

Subsequently, in step S352, the learning section 460 displays the update of the importance degrees of the feature points on the monitor 700 and notifies the update to the user. By displaying the update of the importance degrees of the feature points on the monitor 700, it is possible to more surely notify the update to the user. The user can easily check the update. Information displayed on the monitor 700 is not particularly limited. However, examples of the information include, as shown in FIG. 6, a correct answer position/posture 3D model in which the region S where the difference is large is visualized, feature points, importance degrees of which are changed, and importance degrees before and after update of the feature points. By selecting and displaying only the feature points, the importance degrees of which are changed, in this way, it is possible to reduce an amount of information displayed on the monitor 700. The user can easily check the change of the importance degrees. By displaying the importance degrees after the update, the user can easily check in what kind of weighting object recognition is performed in future. In particular, by displaying the importance degrees before and after the update, the user can easily check the change of the importance degrees. Although not shown in FIG. 6, where in the 3D model the feature points are located may be visually displayed.

As shown in FIG. 7, the amount of information may be further reduced from the example shown in FIG. 6. Among the feature points, the importance degrees of which are updated, only the feature points, the importance degrees of which after the update are equal to or smaller than a predetermined value, and the importance degrees of the feature points may be displayed on the monitor 700. In FIG. 7, only the feature points, the importance degrees of which after the update are equal to or smaller than 10, are displayed. Consequently, it is possible to further reduce the amount of information displayed on the monitor 700. The user can more easily check the change of the importance degrees.

Subsequently, in step S353, the learning section 460 requests the user to determine the propriety of the importance degree update. By requesting the user to determine the propriety of the update, it is more likely that abnormal update can be prevented. In response to the request of the learning section 460, the user determines the propriety using various input devices such as a keyboard and a mouse. However, a notifying method and a determining method are not particularly limited.

When the user rejects the update of the importance degrees, the learning section 460 repeats steps S351 to S353 until the update of the importance degrees is admitted. When repeating the steps, the learning section 460 may change conditions and the like of a method of determining importance degrees from the last time. However, not only this, but, for example, the importance degrees of the feature points determined by the learning section 460 may be set as an initial state. The user may increase and reduce the importance degrees of the feature points from the initial state to determine preferable importance degrees. On the other hand, when the user admits the update of the importance degrees, in step S354, the learning section 460 updates the importance degrees of the feature points of the correct answer position/posture 3D model.

Step S3 explained above is repeatedly performed about 3D models in various positions/postures to update importance degrees of the feature points of the 3D models in the various positions/postures. Importance degrees may be updated about all 3D models in 360°. However, in the 3D models, there are a position/posture shown in FIG. 8 in which the nut N, which is a large difference point, easily appears in a contour shape and a position/posture shown in FIG. 9 in which the nut N, which is a large difference, less easily appears in a contour shape. In the case of the position/posture shown in FIG. 9 in which the nut N less easily appears in the contour shape, since influence of the large difference in the nut N on estimation of a position/posture is small, the estimation of a position/posture can be accurately performed. In contrast, in the case of the position/posture shown in FIG. 8 in which the nut N easily appears in the contour shape, since influence of the large difference in the nut N on estimation of a position/posture is large, estimation accuracy of a position/posture is markedly deteriorated. Accordingly, it is preferable to perform the update of the importance degrees of the feature points only about the 3D model of the position/posture shown in FIG. 8 in which the nut N easily appears in the contour shape and not to perform the update of the importance degrees of the feature points about the 3D model of the position/posture shown in FIG. 9 in which the nut N less easily appears in the contour shape. Consequently, it is possible to reduce a time and labor required for the update of the importance degrees.

As explained above, in step S31, the recognizing section 450 estimates, using a learning model, a position/posture of the object X relating to measurement data. In this case, the recognizing section 450 calculates a confidence degree of an estimation result based on a coincidence rate and the like of feature points. The confidence degree is lower in a position/posture in which the nut N, which is the difference point, more easily appears in the contour shape. Therefore, the update of the importance degrees of the feature points only has to be performed only about the correct answer position/posture 3D model in which the confidence degree is equal to or smaller than a predetermined value. Consequently, it is possible to reduce a time and labor required for the update of the importance degrees.

### Step S4

Subsequently, in step S4, the learning section 460 performs relearning using the importance degrees updated in step S3 and generates a new learning model. Consequently, a learning model considering levels of the importance degrees is obtained. In the relearning, about a position/posture in which a confidence degree is lower than the predetermined value, it is preferable to, compared with the last learning time, reduce the number of feature points extracted from the inside of a region where a difference of feature points is large, that is, the region S overlapping the nut N and increase the number of feature points extracted from the outside of the region S. More preferably, the number of feature points extracted from the inside of the region S is set to zero. That is, it is preferable to perform the relearning while limiting the relearning to a region where a difference of feature points is equal to or smaller than a predetermined value (an importance degree is equal to or larger than a predetermined value). Consequently, in later object recognition work, it is possible to suppress occurrence of feature points having a large difference. Accuracy of object recognition is improved.

The teaching work is explained above. With such teaching work, the 3D model is not updated and only the importance degrees of the feature points are updated. Accordingly, it is possible to reduce a time required for the relearning in step S4. Therefore, it is possible to quickly start the object recognition work.

Subsequently, the object recognition work and the gripping work are explained with reference to the flowchart of FIG. 10.

First, in step S51, the camera 300 images the object X on the placing table 200. The image acquiring section 440 acquires image data obtained by the imaging. Subsequently, in step S52, the recognizing section 450 extracts the object X from the image data and generates measurement data of the object X. Subsequently, in step S53, the recognizing section 450 estimates, using the learning model obtained in step S4, a position/posture of the object X relating to the measurement data. Consequently, the object recognition work ends. With such a method, the position/posture of the object X is estimated based on the learning model in which superiority and inferiority are set for the importance degrees of the feature points. Therefore, it is possible to accurately estimate the position/posture of the object X.

Subsequently, in step S6, the communication section 480 transmits a command for gripping the object X, the position/posture of which is estimated, to the robot control device 640 and executes the gripping work for the object X by the robot 600. Consequently, the gripping work ends.

The robot system 100 is explained above. As explained above, such a robot system 100 includes the gripping section 500 that grips the object X, which is the target object, the camera 300, which is the imaging device that images the object X, and the object recognition processing device 400 that performs object recognition based on an image captured by the camera 300. The object recognition processing device 400 performs the image recognition for the object X through step S2 for obtaining measurement data of the object X, which is the target object, step S3 for comparing the 3D model having the plurality of feature points and the measurement data and updating the importance degrees of the plurality of feature points based on the differences between the 3D model and the measurement data, step S4 for performing learning using the updated importance degrees, and step S53 for performing the object recognition for the object X based on a result of the learning. The gripping section 500 grips the object X based on a result of the object recognition by the object recognition processing device 400. With such a configuration, since the 3D model is not updated and only the importance degrees of the feature points are updated, it is possible to reduce a time required for the relearning in step S4. Accordingly, it is possible to quickly start the object recognition work. Since the position/posture of the object X is estimated based on the learning model in which superiority and inferiority are set for the importance degrees of the feature points, it is possible to accurately estimate the position/posture of the object X.

As explained above, the image recognition method used by the robot system 100 includes step S2 for obtaining measurement data of the object X, which is the target object, step S3 for comparing the 3D model having the plurality of feature points and the measurement data and updating the importance degrees of the plurality of feature points based on the differences between the 3D model and the measurement data, step S4 for performing learning using the updated importance degrees, and step S53 for performing the object recognition for the object X based on a result of the learning. With such a method, since the 3D model is not updated and only the importance degrees of the feature points are updated, it is possible to reduce a time required for the relearning in step S4. Accordingly, it is possible to quickly start the object recognition work. Since the position/posture of the object X is estimated based on the learning model in which superiority and inferiority are set for the importance degrees of the feature points, it is possible to accurately estimate the position/posture of the object X.

In such an image recognition method, as explained above, the importance degree is set lower for the feature point having the larger difference from the measurement data. Alternatively, the importance degree is set higher for the feature point having the smaller difference from the measurement data. Consequently, the importance degree of the feature point having the larger difference decreases relatively to the importance degree of the feature point having the smaller difference. Therefore, it is possible to accurately estimate the position/posture of the object X.

In such an image recognition method, as explained above, the feature points, the importance degrees of which are changed by the update, are displayed on the monitor 700, which is the image display device. Consequently, it is possible to more surely notify the update to the user. The user can easily check the update.

In such an image recognition method, the importance degrees after the update of the feature points, the importance degrees of which are changed by the update, are displayed on the monitor 700. Consequently, it is possible to reduce an amount of information displayed on the monitor 700. The user can easily check the update of the importance degrees.

In such an image recognition method, as explained above, among the feature points, the importance degrees of which are changed by the update, only the importance degrees of the feature points, the importance degrees of which after the update are equal to or smaller than the predetermined value, are displayed on the monitor 700. Consequently, it is possible to further reduce the amount of information displayed on the monitor 700. The user can more easily check the change of the importance degrees.

In such an image recognition method, as explained above, in step S4 for generating a learning model, in the 3D model, the feature points in the region where the coincidence degree is high present outside the region where the difference is equal to or smaller than the predetermined value, that is, the region S are extracted and learned. Consequently, in the object recognition work, it is possible to prevent occurrence of feature points having a large difference. Accuracy of the object recognition is improved.

The image recognition method and the robot system according to the present disclosure are explained above based on the illustrated embodiment. However, the present disclosure is not limited to this. The components of the sections can be replaced with any components having the same functions. Any other components may be added.

What is claimed is:

1. An image recognition method comprising:
obtaining measurement data of a target object;
comparing a 3D model having a plurality of feature points and the measurement data and updating importance degrees of the plurality of feature points based on differences between the 3D model and the measurement data;
performing learning using the updated importance degrees; and
performing object recognition for the target object based on a result of the learning.

2. The image recognition method according to claim 1, wherein the importance degrees are set lower for the feature points having larger differences from the measurement data.

3. The image recognition method according to claim 1, wherein the importance degrees are set higher for the feature points having smaller differences from the measurement data.

4. The image recognition method according to claim 1, wherein the feature points, the importance degrees of which are changed by the update, are displayed on an image display device.

5. The image recognition method according to claim 4, wherein the importance degrees after the update of the feature points, the importance degrees of which are changed by the update, are displayed on the image display device.

6. The image recognition method according to claim 5, wherein only the importance degrees of the feature points, the importance degrees of which after the update are equal to or smaller than a predetermined value, among the feature points, the importance degrees of which are changed by the update, are displayed on the image display device.

7. The image recognition method according to claim 1, wherein, in the learning, in the 3D model, the feature points within a region where the differences are equal to or smaller than a predetermined value are extracted and learned.

8. A robot system comprising:
a gripping section configured to grip a target object;
an imaging device configured to image the target object; and
an object recognition processing device configured to recognize an object based on an image captured by the imaging device, wherein
the object recognition processing device performs image recognition for the target object through a step of obtaining measurement data of the target object, a step of comparing a 3D model having a plurality of feature points and the measurement data and updating importance degrees of the plurality of feature points based on differences between the 3D model and the measurement data, a step of performing learning using the updated importance degrees, and a step of performing object recognition for the target object based on a result of the learning, and
the gripping section grips the target object based on a result of the object recognition by the object recognition processing device.
